(19) United States
(12) Patent Application Publication
(10) Pub. No.: US 2026/0001261 A1
(43) Pub. Date: Jan. 1, 2026

(54) METHOD FOR PRODUCING POLYCARBONATE RESIN MOLDED PRODUCT

(71) Applicant: MITSUBISHI GAS CHEMICAL COMPANY, INC., Tokyo (JP)

(72) Inventor: Satoshi NAGAI, Tokyo (JP)

(73) Assignee: MITSUBISHI GAS CHEMICAL COMPANY, INC., Tokyo (JP)

(21) Appl. No.: 19/104,454

(22) PCT Filed: Aug. 28, 2023
(86) PCT No.: PCT/JP2023/030865

§ 371 Date: Feb. 18, 2025

(30) Foreign Application Priority Data
Sep. 1, 2022 (JP) 2022-139308

(51) Int. Cl. B29C 45/00; B29C 45/18; B29K 69/00

(52) U.S. Cl. CPC B29C 45/0001; B29C 45/1816; B29C 2948/92885; B29K 2069/00

(57) ABSTRACT

Provided is a method for producing a polycarbonate resin molded product by molding a polycarbonate resin using an injection molding machine, including: starve feeding polycarbonate resin particulates to an injection molding machine; generating a plasticized resin by plasticizing the particulates inside the injection molding machine; and producing a molded product from the plasticized resin. The water content of the particulates which are starve fed to the injection molding machine is not more than 0.3 wt %.

### TECHNICAL FIELD

The present invention relates to a method for producing a polycarbonate resin molded product, and more specifically relates to a method for producing a polycarbonate resin molded product by hungry feeding of polycarbonate resin granules to an injection molding machine.

### BACKGROUND ART

Heretofore, various methods for producing a polycarbonate resin molded product have been proposed as disclosed in, for example, Patent Literatures 1 to 3.

Patent Literature 1 discloses a method for producing a molded body, in which the molded body is formed using a vent-type injection molding apparatus by feeding resin pellets in a hungry state (Abstract, 0017, 0018, and 0026). Patent Literature 2 discloses a method for producing a polycarbonate resin molding material, in which a pellet-shaped molding material is produced by hungry feeding of polycarbonate resin granules to an extruder (0015, 0030, 0035). Patent Literature 3 discloses a method for producing a polycarbonate resin molded product, in which when pellets of a polycarbonate resin composition are molded by an injection molding machine, the pellets are fed to the injection molding machine by hungry feeding (claims 1 and 2).

### CITATION LIST

### Patent Literature

Patent Literature 1: International Publication No. WO 2019/9362
Patent Literature 2: Japanese Patent Laid-Open No. 2011-37164
Patent Literature 3: Japanese Patent Laid-Open No. 2016-165817

### SUMMARY OF INVENTION

### Technical Problem

Polycarbonate resin molded products produced by conventional production methods have a problem that the molded products contain gas bubbles (silver streaks are generated).

It is therefore an object of the present invention to provide a method for producing a polycarbonate resin molded product containing no gas bubbles.

### Solution to Problem

The present invention includes the following aspects.

### [Aspect 1]

A method for producing a molded product of a polycarbonate resin by molding the polycarbonate resin with an injection molding machine, the method including the steps of:
feeding granules of the polycarbonate resin to the injection molding machine by hungry feeding;
plasticizing the granules in the injection molding machine to generate a plasticized resin; and
molding the plasticized resin into the molded product, wherein
the granules fed by the hungry feeding to the injection molding machine has a water content of 0.3 wt % or less.

### [Aspect 2]

The method according to aspect 1, wherein 50 wt % or more of the granules fed by the hungry feeding has a particle diameter of 200 to 2000 μm.

### [Aspect 3]

The method according to aspect 2, wherein the granules fed by the hungry feeding has a specific surface area of 0.01 m²/g or more.

### [Aspect 4]

The method according to aspect 1, wherein the granules fed by the hungry feeding has a flake or granular shape.

### [Aspect 5]

The method according to aspect 1, wherein the granules fed by the hungry feeding has a water content of 0.01 wt % or more.

### [Aspect 6]

The method according to aspect 5, wherein the granules fed by the hungry feeding has a water content of 0.06 wt % or more.

### [Aspect 7]

The method according to aspect 1, wherein the granules fed by the hungry feeding has a water content of 0.20 wt % or less.

### [Aspect 8]

The method according to aspect 1, wherein the granules fed by the hungry feeding has a water content of 0.01 wt % or more and 0.20 wt % or less.

### [Aspect 9]

The method according to aspect 1, wherein the granules fed by the hungry feeding has a specific surface area of 0.01 m²/g or more, and 50 wt % or more of the granules fed by the hungry feeding has a particle diameter of 200 to 2000 μm.

### [Aspect 10]

The method according to aspect 1, wherein the injection molding machine includes a hungry feeder that is of any one of a screw type, a vibration type, a belt type, a table type, and a circle type.

### [Aspect 11]

The method according to aspect 10, wherein a screw rotation speed of the screw-type hungry feeder of the injection molding machine is 20 to 500 rpm.

### [Aspect 12]

The method according to aspect 1, wherein in the step of plasticizing the granules, the granules is plasticized for 10 to 60 seconds.

### [Aspect 13]

The method according to aspect 1, wherein the injection molding machine includes a cylinder, and a temperature in the cylinder is 230 to 360° C.

### [Aspect 14]

The method according to aspect 13, wherein a screw is disposed in the cylinder, and a rotation speed of the screw is 10 to 200 rpm.

### ADVANTAGEOUS EFFECTS OF INVENTION

### Brief Description of Drawings

FIG. 1 is a configuration diagram of an injection molding machine used in a method for producing a polycarbonate resin molded product of the present invention.

FIG. 2 is a configuration diagram of a hungry feeder of the injection molding machine shown in FIG. 1.

FIG. 3 is a configuration diagram of a vent-equipped injection molding machine used in the method for producing a polycarbonate resin molded product of the present invention.

### DESCRIPTION OF EMBODIMENTS

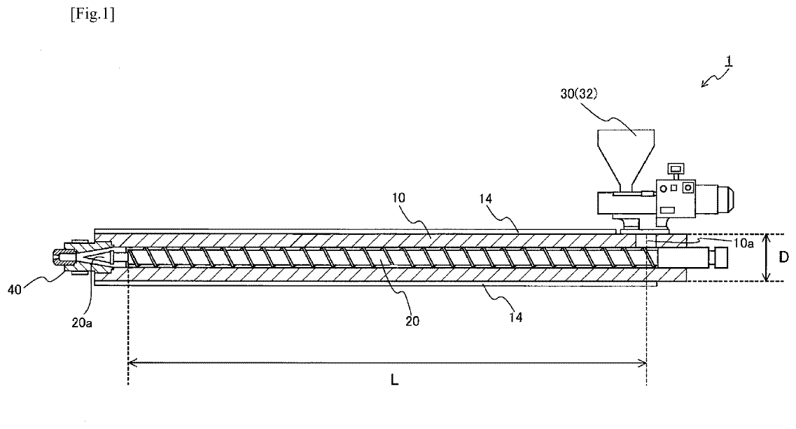

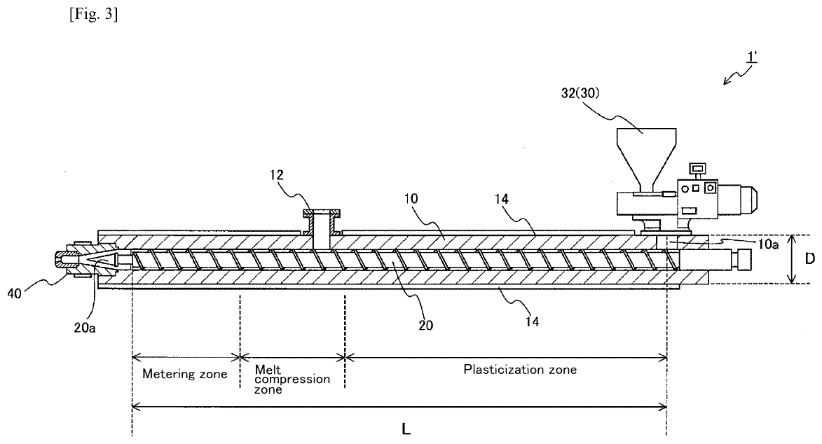

A method for producing a polycarbonate resin molded product according to an embodiment of the present invention will be described. The method for producing a polycarbonate resin molded product according to the present embodiment uses an injection molding machine 1 shown in FIG. 1 or an injection molding machine 1′ shown in FIG. 3.

### Injection Molding Machine

First, the injection molding machine used in the present embodiment will be described.

The injection molding machine 1 is constituted from a cylinder 10, a screw 20 rotatably housed in the cylinder 10, a hungry feeder 30 connected immediately above a supply port 10a located on the injection direction rear-end side of the cylinder 10, and a nozzle 40 connected to the injection direction front-end side of the cylinder 10. A head portion 20a of the screw 20 is inserted into the nozzle 40. On the outer peripheral surface of the cylinder 10, a heater 14 is disposed.

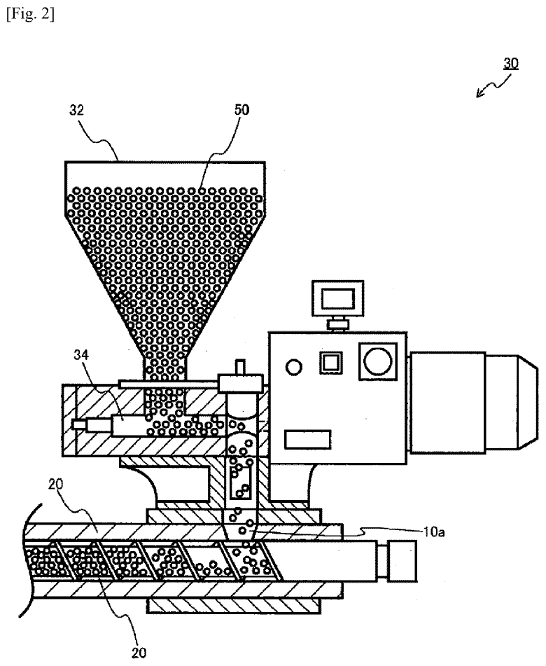

As shown in FIG. 2, the hungry feeder 30 is constituted from a hopper 32 to receive granules 50 and a screw feeder 34 to feed the granules 50 from the hopper 32 into the cylinder 10 through the supply port 10a.

The injection molding machine 1′ shown in FIG. 3 is the same in configuration as the injection molding machine 1 except that the cylinder 10 is equipped with a vent 12 for degassing, and therefore the identical components will not repeatedly be described. The injection molding machine 1′ has a vent 12 provided at one position in the middle of the cylinder 10 in the longitudinal direction thereof. It is not always necessary to provide such a vent, but, for example, a volatile component can be discharged through the vent 12. In this case, the vent 12 is preferably provided on the front-end side from a plasticization zone (located on the rear-end side) in the cylinder 10 in order to efficiently discharge the volatile component through the vent 12.

As shown in FIG. 3, the cylinder 10 of the injection molding machine 1′ includes a plasticization zone, a melt compression zone, and a metering zone provided from the hopper 32 side (hungry feeder 30 side) toward the front-end injection side (extruder outlet side), and the screw 20 in each of the zones is designed according to the purpose of the zone.

The plasticization zone is a zone for melting and plasticizing the granules 50 fed by the hungry feeder 30. In this plasticization zone, a volatile component is generated from the granules 50. The melt compression zone is a zone where a molten resin from the plasticization zone is further melted and compressed to remove the volatile component. The vent 12 is preferably provided in this zone. The metering zone is a zone where the polycarbonate resin is stabilized before its discharge and the amount of the resin to be discharged is adjusted to prevent its fluctuation.

In the injection molding machine 1 or 1′used in the present application, the L/D (extrusion-direction length/diameter) of the cylinder 10 is preferably 10 or more, more preferably 10 to 40, even more preferably 10 to 30. It should be noted that the L/D of an injection molding machine used in Examples is 20. The extrusion-direction length L of the cylinder 10 herein refers to a length from the center of the supply port 10a for feeding a raw material such as the granules 50 to the cylinder 10 to the base end of head portion 20a of the screw 20, and the diameter of the cylinder 10 herein refers to a diameter of the cylindrical cylinder.

The length of the plasticization zone is preferably about ½ to 7/10 of the extrusion-direction length L of the injection cylinder 10. The length of the melt compression zone is preferably about 1/10 to 3/10 of the extrusion-direction length L of the cylinder 10, and the length of the metering zone is preferably about 1/10 to 3/10 of the extrusion-direction length L of the cylinder 10.

The injection molding machine 1 or 1′ may be of any one of a screw type, a vibration type, a belt type, a table type, and a circle type. The screw rotation speed of the screw-type injection molding machine may be, for example, 20 to 500 rpm. It should be noted that the screw rotation speed is preferably 20 to 300 rpm, more preferably 70 to 300 rpm, even more preferably 80 to 250 rpm, most preferably 150 to 250 rpm.

The time of plasticization of the granules 50 in the cylinder 10 on heating by the heater 14 is preferably 10 to 60 seconds, more preferably 10 to 40 seconds, even more preferably 10 to 30 seconds. It should be noted that in each of Examples that will be described later, the time of plasticization was set to 13 to 26 seconds; however, a general molded product, especially a large molded product (with a thickness of 4 to 7 mm) requires a long time of about 40 seconds. For example, in the case of a thick molded product for glazing (with a thickness of, for example, about 5 mm), a metering time of about 40 seconds is required. In the case of a molded product as a general head lamp, the time of plasticization of the granules 50 is 15 to 30 seconds and the cooling time of the molded product is 25 to 40 seconds, and therefore a molding cycle is 50 to 70 seconds.

The temperature in the cylinder 10 may be 230 to 360° C. The hopper 32-side (hungry feeder 30-side) temperature in the cylinder 10 is preferably 230 to 350° C., more preferably 260 to 340° C., even more preferably 280 to 330° C. (corresponding to temperatures in Examples).

The front-end (nozzle 40-side) temperature in the cylinder 10 is preferably 230 to 360° C., more preferably 270 to 350° C., even more preferably 290 to 340° C. (corresponding to temperatures in Examples). It should be noted that considering a case where disk-grade granules such as Iupilon H4000 are used, the lower limit of the temperature range needs to be a temperature (230° C.) lower than the temperatures in Examples.

### Production Method

The outline of the method for producing a polycarbonate resin molded product will be described. The production method includes, when a polycarbonate resin molded product is produced by molding a polycarbonate resin with the injection molding machine 1, the step of feeding the granules 50 of a polycarbonate resin by hungry feeding into the cylinder 10 from the hungry feeder 30, the step of plasticizing the granules 50 in the cylinder 10 heated by the heater 14 by rotation of the screw 20 to generate a plasticized resin, and the step of extruding the plasticized resin from the nozzle 40 by rotation of the screw 20 and molding the same into a molded product.

### Granules

The production method according to the present embodiment may use polycarbonate resin granules. The granules 50 to be used are preferably, but not limited to, a flake-shaped or granular material. The specific surface area of the granules 50 is preferably 0.01 m²/g or more. Fifty percent by weight of the granules 50 preferably has a particle diameter of 200 to 2000 μm, more preferably has a particle diameter of 200 to 1500 μm, and even more preferably has a particle diameter of 200 to 1200 μm. It should be noted that the particle diameter of the granules 50 can be measured by a method based on JIS K0069 (Test methods for sieving).

The granules 50 may have a predetermined water content (water absorption rate). The predetermined water content of the granules 50 is preferably 0.3 mass % or less, more preferably 0.2 mass % or less. Further, the water content of the granules 50 is preferably 0.01 mass % or more, more preferably 0.06 mass % or more, even more preferably 0.065 mass % or more. The water content range of the granules 50 is preferably 0.06 mass % (600 ppm) to 0.3 mass % (3000 ppm), more preferably 0.065 mass % (650 ppm) to 0.2 mass % (2000 ppm), even more preferably 0.065 mass % (650 ppm) to 0.17 mass % (1700 ppm). When the granules 50 had such a predetermined water content or a water content within such a range, a resulting molded product was superior in hue and generation of gas bubbles (silver streaks) could be prevented, which resulted in a further improvement in hue.

In a conventional method for producing a polycarbonate resin molded product, a raw material is dried before molding to remove moisture (to prevent generation of silver streaks, i.e., gas bubbles in the molded product). In the present invention, contrary to expectations, a molded product having an excellent YI value (hue) was obtained by hungry feeding of granules to an injection molding machine in a state where the granules had a predetermined water content (i.e., in a state where the granules were not dried). This fact can be understood from comparison between Examples 1 to 8 and Examples 9 and 10 that will be described later. The production method of the present invention makes it possible to simplify a molding process and reduce the load of quality assurance control by omitting the step of drying granules.

Injection molding can be performed by feeding the polycarbonate resin granules 50 having a water content of 0.3 mass % or less to the injection molding machine 1 or 1′. When the water content of the granules 50 is 0.3 mass % or less and injection molding is performed by, for example, the injection molding machine 1′ having a vent, a volatile component can stably be discharged through the vent 12, which makes it easy to obtain molded products uniform in quality.

From the viewpoint of the efficiency of discharging a volatile component, the water content of the granules 50 is preferably low to some extent. For example, the water content is preferably 0.2 mass % or less, more preferably 0.1 mass % or less. Also from the viewpoint of metering stability of the granules 50, the water content is preferably within such a range.

The granules 50 used in the present application may previously be dried before fed to the injection molding machine 1 or 1′ or may directly be used without being dried. However, the granules 50 are preferably directly used without being dried because Examples confirm that molded products having a small YI value can be obtained.

It should be noted that a polycarbonate resin obtained by an interface method is produced in the form of flakes (i.e., as granules) in its production process, and the obtained flakes are pelletized. Usually, the polycarbonate resin pellets are molded into a molded product. On the other hand, the present invention has a merit that a pelletizing step can also be omitted.

### Hungry Feeding

In the production method of the present invention, polycarbonate resin granules are fed by hungry feeding to the injection molding machine 1 or 1′. When hungry feeding is not performed, the polycarbonate resin as a raw material is usually fed by allowing it to fall under its own weight through the supply hopper 32 attached to the supply port 10a located on the rear-end side of the cylinder 10 of the injection molding machine 1 or 1′. In this case, a route from the hopper 32 to the screw 20 through the supply port 10a of the injection cylinder is filled with the granules 50.

On the other hand, when the polycarbonate resin granules 50 are fed by hungry feeding to the injection molding machine 1 or 1′, as shown in FIG. 2, the hungry feeder 30 charges a predetermined amount of the granules 50 from the hopper 32 through the supply port 10a of the cylinder 10 with the use of the screw feeder 34 while adjusting the amount of the polycarbonate resin granules 50 to be fed.

By controlling the amount of the polycarbonate resin granules 50 to be charged in such a manner, part of a screw bed (thread groove portion of screw) of the screw 20 immediately below the supply port 10a is exposed without being covered with the granules 50. By feeding the granules 50 in such a state, hungry feeding is performed.

When the raw material (granules) is fed in a hungry state, a gap (space) where the raw material is absent is created in the supply port 10a of the cylinder 10, and therefore a gas component or the like generated in the injection cylinder 10 is discharged to the outside of the system through the gap. That is, it can be considered that the supply port 10a serves the same function as a vent, and therefore the efficiency of discharging a volatile component and water vapor is improved so that a molded product that is superior in hue (YI) and contains few gas bubbles is obtained.

Such a hungry feeder for performing hungry feeding is commercially available. For example, “Hungry Feeder HF-1” manufactured by Nihon Yuki Co., Ltd. can be used, which was used in Examples that will be described later.

The rotation speed of the screw feeder 34 that performs hungry feeding of the granules is preferably 20 to 500 rpm, more preferably 70 to 300 rpm, 80 to 250 rpm, or 150 to 250 rpm.

The merits of the hungry feeding are as follows.
1. The retention time of the granules 50 and the plasticized resin in the cylinder 10 is reduced, and therefore a hue change of a molded product and a reduction in molecular weight can be prevented.
2. In the case of the injection molding machine 1′, a volatile gas is discharged to the outside of the system through the vent 12, and therefore silver streaks are much less likely to appear.
3. Plasticization and melting of the granules 50 are stably performed, and therefore surging is less likely to occur and uniform plasticization can be achieved.
4. A melting start position is located nearer to the front end of the cylinder 10, and therefore material purging becomes easy and the amount of a purging agent to be used is reduced.
5. Abrasion of the screw 20 is prevented.
6. The rotation torque of the screw 20 is reduced, and therefore the amount of electric power is reduced.

The hungry feeder 30 is not limited as long as it is a feeder that can feed granules, such as a screw-type feeder, a vibration-type feeder, a belt-type feeder, a circle-type feeder, or a table-type feeder. However, the screw feeder 34 shown as an example in Examples is preferably used due to the ease of precision molding. In the case of hungry feeding, the rotation speed of the screw feeder 34 of the hungry feeder 30 varies depending on its screw size and groove shape, and therefore it is not necessary to set the rotation speed of the screw feeder 34 in correlation to the rotation speed of the screw 20 of the injection molding machine 1 or 1′. However, the rotation speed of the screw feeder 34 and the rotation speed of the screw 20 have, for example, the following relationship. Those in Examples that will be described later satisfy the relational expression 1.

Rotation speed of hungry feeder≥Rotation speed of injection molding machine

### (Relational Expression 1)

In the relational expression 1, “rotation speed of hungry feeder” refers to the rotation speed of the screw feeder 34, and “rotation speed of injection molding machine” refers to the rotation speed of the screw 20. It should be noted that when the screw feeder 34 of the hungry feeder 30 is made larger than the screw 20 of the injection molding machine, the relational expression 1 is not established.

A feed rate in hungry feeding is not limited as long as metering (plasticization) is completed within a required cooling time. If a metering time is longer than such a required cooling time, an excess metering time (plasticization time) is required after the completion of cooling, which causes a problem that a molding cycle becomes unnecessarily long. In order to solve such a problem, operation is preferably performed in such a manner that the relationship represented by the above relational expression 1 is satisfied.

### Vent

When pellets are fed from the hopper 32 instead of granules, installation of a vent generally tends to reduce a YI value (i.e., to improve hue). However, in a case where granules (flakes) were fed by hungry feeding in Examples that will be described later, molded products having a lower YI value (superior in hue) were obtained when a vent was not provided. The reason for this is considered to be that when the vent 12 is provided, the screw 20 has a dulmage portion (thread groove portion), and therefore the resin is colored due to shearing heat generation. That is, the production method of the present invention has a merit that a molded product excellent in hue can be obtained without providing a vent.

The vent 12 puts a load on the work of operating the injection molding machine 1′ because it is necessary to give consideration to prevent vent-up (clogging of a vent port with a resin) or entry of foreign matter through a vent port during operation of the molding machine. Even when the vent 12 is not provided as in the case of the injection molding machine 1, a resulting molded product has a low YI value (excellent hue). Therefore, the productivity of molded products is improved by reducing a workload. Further, when the vent 12 is not provided, the melt compression zone can also be omitted.

Further, as a matter of fact, installation of a vent requires a high equipment cost. Further, installation of a vent involves thorough management of the vent, complicates a molding process, and requires effort to control the molding process. For example, a vent port needs to be cleaned to remove a resin or a volatile material attached thereto, and in the event of vent-up, recovery requires great time and effort. Further, when the type of resin to be used is changed, there is a problem that it takes a long time to purge a resin from the screw 20 or a large amount of a resin for purging is consumed.

As a result, molded products having a lower YI value (i.e., being superior in quality) were obtained when granules (flakes) was fed by hungry feeding than when a vent was provided to improve hue or prevent generation of gas bubbles. Comparison between Example 11 where a vent was provided and Example 2 where a vent was not provided confirms that a superior hue was achieved when a vent was not provided. Example 11 and Example 2 were performed under the same conditions except for the presence or absence of a vent. It should be noted that even in the case of Example 11, a molded product whose YI value was low to some extent was obtained.

### Injection Molding Conditions

In the present invention, as described above, conventional injection molding conditions can be used except that granules (flake-shaped) of a polycarbonate resin having a water content of 0.3 mass % or less is fed by hungry feeding using an injection molding machine. The cylinder temperature of the injection molding machine 1 or 1′ is appropriately adjusted depending on the melt temperature or melt viscosity of a resin (granules) to be used. For example, the cylinder temperature of the injection molding machine 1 or 1′ is preferably 230 to 360° C. and a mold temperature is preferably 60 to 120° C.

### Conclusion

Conventional polycarbonate resin molded products yet have a problem that gas bubbles (silver streaks) are generated in the molded products. It is usually known that in terms of handleability during molding and precision feeding to a molding machine, granules (flake-shaped) of a polycarbonate resin is processed into pellets, and the pellets are subjected to a drying step and then to molding processing.

On the other hand, the present invention provides a production method in which polycarbonate resin granules having a predetermined water content are fed by hungry feeding to a supply port of an injection molding machine. This made it possible to obtain a molded product containing few gas bubbles and having a low YI value. Further, a molded product having a lower YI value could be obtained by omitting the above-described drying step. It should be noted that the production method of the present invention was more effective at increasing the rate of decrease in YI value when polycarbonate resin granules were used than when polycarbonate resin pellets were used.

### EXAMPLES

Examples of the present invention and Comparative Examples will be described. As the injection molding machine 1 or 1′, “NEX-50-4-5EG” manufactured by NISSEI PLASTIC INDUSTRIAL CO., LTD. was used. As the hungry feeder 30, “Hungry Feeder HF-1” manufactured by Nihon Yuki Co., Ltd. was used. As the granules 50 (flakes), “Iupilon (R) E-2000F” manufactured by Mitsubishi Engineering-Plastics Corporation was used.

As a metering time (plasticization time), the time during which the screw 20 of the injection molding machine 1 or 1′ was rotated was measured by a measuring unit of the injection molding machine 1 or 1′ and displayed on a display unit. A YI value was determined by measuring a hue at a thickness of 3 mm of a 50×80×3 mm molded body formed as a test specimen with a colorimeter. The colorimeter was “SE6000” manufactured by NIPPON DENSHOKU INDUSTRIES CO., Ltd. The presence or absence of gas bubbles in a molded product was determined by visually observing the external appearance of the test specimen (50×80×3 mm) used for measuring a YI value. The case with silver streaks generated was evaluated as “gas bubbles present”, and the case without silver streaks generated was evaluated as “gas bubbles absent”.

### Example 1

Injection molding was performed by hungry feeding under operation conditions shown in Table 1 using Iupilon (R) E-2000 flakes as granules (flakes) and the injection molding machine 1 (NEX-50-4-5EG) shown in FIG. 1 having a hopper equipped with the hungry feeder 30 (Hungry Feeder HF-1). The screw of this injection molding machine is a low-compression screw having an L/D ratio of 20 and a screw diameter of 26 mm. The molding conditions and physical properties of an obtained molded product are shown in Table 1.

### Examples 2 to 8

Injection molding was performed in the same manner as in Example 1 except that the operation conditions were changed as shown in Table 1. The molding conditions and physical properties of an obtained molded product are shown in Table 1.

### Examples 9 and 10

Granules (Iupilon (R) E-2000 flakes) were dried with a hot-air drier at 120° C. for 2 hours. Injection molding was performed in the same manner as in Example 1 except that these granules were used and the operation conditions were changed as shown in Table 1. The molding conditions and physical properties of an obtained molded product are shown in Table 1.

### Example 11

Injection molding was performed in the same manner as in Example 2 except that the screw had a vent and a melt compression zone. The molding conditions and physical properties of an obtained molded product are shown in Table 1.

### Comparative Examples 1 to 4

Injection molding was performed in the same manner as in Example 1 except that the hungry feeder (Hungry Feeder HF-1) was not installed and the operation conditions were changed as shown in Table 1. The molding conditions and physical properties of an obtained molded product are shown in Table 2.

### Comparative Examples 5 to 9

Injection molding was performed in the same manner as in Example 1 except that the granules (Iupilon (R) E-2000 flakes) used as a polycarbonate resin raw material was changed to pellets (“Iupilon (R) E-2000 pellets” manufactured by Mitsubishi Engineering-Plastics Corporation) and the operation conditions were changed as shown in Table 1. The molding conditions and physical properties of an obtained molded product are shown in Table 2.

It was found that in the case of pellet molding, a molded body superior in hue and containing no gas bubbles was obtained when the pellets were dried before molding (Comparative Examples 5 and 6) and that in the case of hungry feeding of flakes, a superior hue was achieved when drying was not performed (see the results of Examples 1 to 8 and Examples 9 and 10). Therefore, in Examples 1 to 8 and 11, molded bodies superior in hue were obtained without a drying step, which reduced energy consumption and saved effort.

In Examples, the hungry feeder 30 (Hungry Feeder HF-1) feeds the granules while mainly discharging, through a discharge port, water vapor and heptane and methylene chloride used in the process of producing a polycarbonate resin by an interface method. The discharge port is configured in such a manner that the pressure therein can slightly be reduced by a vacuum ejector to smoothly discharge gas in the system.

TABLE 1

| | | | | | | Cylinder setting | | | | | |
|---|---|---|---|---|---|---|---|---|---|---|---|
| | | | | | | temperature | | | | Gas | |
| | | | | Feeder | | (° C.) | | Screw | | bubbles | |
| | Raw material | | | rotation | Plasticization | Rear- | Front- | rotation | | in | Water |
| | Polycarbonate | | Hungry | speed | time | end | end | speed | YI | molded | content |
| | resin | Drying | feeder | (rpm) | (sec) | side | side | (rpm) | value | product | (ppm) |
| Example 1 | E-2000 flakes | Undried | Provided | 100 | 25 | 290 | 300 | 100 | 0.86 | Absent | 1640 |
| Example 2 | E-2000 flakes | Undried | | | | 300 | 310 | | 0.86 | Absent | |
| Example 3 | E-2000 flakes | Undried | | | | 310 | 320 | | 0.89 | Absent | |
| Example 4 | E-2000 flakes | Undried | | | | 320 | 330 | | 0.88 | Absent | |
| Example 5 | E-2000 flakes | Undried | Provided | 200 | 13 | 290 | 300 | 100 | 0.90 | Absent | |
| Example 6 | E-2000 flakes | Undried | | | | 300 | 310 | | 0.89 | Absent | |
| Example 7 | E-2000 flakes | Undried | | | | 310 | 320 | | 0.88 | Absent | |
| Example 8 | E-2000 flakes | Undried | | | | 320 | 330 | | 0.90 | Absent | |
| Example 9 | E-2000 flakes | 120° C. × 2 | Provided | 100 | 26 | 290 | 300 | 100 | 1.09 | Absent | 650 |
| | | hrs | | | | | | | | | |
| Example 10 | E-2000 flakes | 120° C. × 2 | Provided | 200 | 14 | 290 | 300 | 100 | 1.07 | Absent | |
| | | hrs | | | | | | | | | |
| Example 11 | E-2000 flakes | Undried | Provided | 100 | 25 | 300 | 310 | 100 | 1.40 | Absent | 1640 |

TABLE 2

| | | | | | | Cylinder setting | | | | | |
|---|---|---|---|---|---|---|---|---|---|---|---|
| | | | | Feeder | | temperature (° C.) | | Screw | | Gas | |
| | Raw material | | | rotation | Plasticization | Rear- | Front- | rotation | | bubbles | Water |
| | Polycarbonate | | Hungry | speed | time | end | end | speed | YI | in molded | content |
| | resin | Drying | feeder | (rpm) | (sec) | side | side | (rpm) | value | product | (ppm) |
| Comparative | E-2000 flakes | Undried | Not | — | 12 | 290 | 300 | 100 | 0.87 | Present | 1640 |
| Example 1 | | | provided | | | | | | | | |
| Comparative | E-2000 flakes | Undried | | | | 300 | 310 | 100 | 0.87 | Present | |
| Example 2 | | | | | | | | | | | |
| Comparative | E-2000 flakes | Undried | | | | 310 | 320 | 100 | 0.87 | Present | |
| Example 3 | | | | | | | | | | | |
| Comparative | E-2000 flakes | Undried | | | | 320 | 330 | 100 | 0.88 | Present | |
| Example 4 | | | | | | | | | | | |
| Comparative | E-2000 pellets | Undried | Not | — | 9 | 290 | 300 | 100 | 1.78 | Present | 2460 |
| Example 5 | | | provided | | | | | | | | |
| Comparative | E-2000 pellets | 120° C. × 4 | Not | — | 9 | 290 | 300 | 100 | 1.61 | Absent | 132 |
| Example 6 | | hrs | provided | | | | | | | | |
| Comparative | E-2000 pellets | Undried | Provided | 33 | 25 | 290 | 300 | 100 | 1.41 | Present | 2460 |
| Example 7 | | | | | | | | | | | |
| Comparative | E-2000 pellets | Undried | Provided | 65 | 14 | 290 | 300 | 100 | 1.46 | Present | |
| Example 8 | | | | | | | | | | | |
| Comparative | E-2000 pellets | 120° C. × 4 | Provided | 33 | 25 | 290 | 300 | 100 | 1.51 | Absent | 132 |
| Example 9 | | hrs | | | | | | | | | |
| Comparative | E-2000 pellets | 120° C. × 4 | Provided | 65 | 14 | 290 | 300 | 100 | 1.54 | Absent | |
| Example 10 | | hrs | | | | | | | | | |

### Conclusion of Examples

Examples 1 to 4 are cases where undried flakes were fed by hungry feeding and Example 9 is a case where dried flakes were fed by hungry feeding. The YI values of Examples 1 to 4 were lower by about 22% than that of Example 9. Examples 5 to 8 are cases where undried flakes were fed by hungry feeding, and Example 10 is a case where dried flakes were fed by hungry feeding. The YI values of Examples 5 to 8 were lower by about 16 to 18% than that of Example 10. In Examples 1 to 8, excellent molded products containing no gas bubbles were obtained. Further, the YI values of Examples 1 to 8 were lower than those of Comparative Examples 7 and 8 where undried pellets were fed by hungry feeding. All the molded products obtained in Examples 1 to 11 were acceptable because they had low YI values and contained no gas bubbles.

Comparative Examples 1 to 4 are cases where undried flakes were used and hungry feeding was not performed. All the molded products obtained in Comparative Examples 1 to 4 were not acceptable because they contained gas bubbles. Comparative Examples 5 to 10 are cases where pellets were used, and all the molded products obtained in Comparative Examples 1 to 5 were not acceptable because they had higher YI values as compared to Examples 1 to 11.

### Reference Signs List

Injection molding machine
1′ Vent-equipped injection molding machine
10 Cylinder
12 Vent
14 Heater
20 Screw
30 Hungry feeder
32 Hopper
34 Screw feeder
40 Nozzle
50 Granules

1. A method for producing a molded product of a polycarbonate resin by molding the polycarbonate resin with an injection molding machine, the method comprising-the steps of:
feeding granules of the polycarbonate resin to the injection molding machine by hungry feeding;
plasticizing the granules in the injection molding machine to generate a plasticized resin; and
molding the plasticized resin into the molded product, wherein
the granules fed by the hungry feeding to the injection molding machine has a water content of 0.3 wt % or less.

2. The method according to claim 1, wherein 50 wt % or more of the granules fed by the hungry feeding has a particle diameter of 200 to 2000 μm.

3. The method according to claim 2, wherein the granules fed by the hungry feeding has a specific surface area of 0.01 m²/g or more.

4. The method according to claim 1, wherein the granules fed by the hungry feeding has a flake or granular shape.

5. The method according to claim 1, wherein the granules fed by the hungry feeding has a water content of 0.01 wt % or more.

6. The method according to claim 5, wherein the granules fed by the hungry feeding has a water content of 0.06 wt % or more.

7. The method according to claim 1, wherein the granules fed by the hungry feeding has a water content of 0.20 wt % or less.

8. The method according to claim 1, wherein the granules fed by the hungry feeding has a water content of 0.01 wt % or more and 0.20 wt % or less.

9. The method according to claim 1, wherein the granules fed by the hungry feeding has a specific surface area of 0.01 m²/g or more, and 50 wt % or more of the granules fed by the hungry feeding has a particle diameter of 200 to 2000 μm.

10. The method according to claim 1, wherein the injection molding machine includes a hungry feeder that is of any one of a screw type, a vibration type, a belt type, a table type, and a circle type.

11. The method according to claim 10, wherein a screw rotation speed of the screw-type hungry feeder of the injection molding machine is 20 to 500 rpm.

12. The method according to claim 1, wherein during the plasticizing of the granules, the granules is plasticized for 10 to 60 seconds.

13. The method according to claim 1, wherein the injection molding machine includes a cylinder, and a temperature in the cylinder is 230 to 360° C.

14. The method according to claim 13, wherein a screw is disposed in the cylinder, and a rotation speed of the screw is 10 to 200 rpm.
